(19) United States
(12) Patent Application Publication
(10) Pub. No.: US 2014/0022283 A1
(43) Pub. Date: Jan. 23, 2014

(54) AUGMENTED REALITY APPARATUS

(71) Applicant: UNIVERSITY HEALTH NETWORK, Toronto (CA)

(72) Inventors: Harley Hau-Lam Chan, Richmond Hill (CA); Michael John Daly, Toronto (CA); Jonathan Crawford IRISH, Toronto (CA)

(73) Assignee: UNIVERSITY HEALTH NETWORK, Toronto (CA)

(21) Appl. No.: 13/947,263

(22) Filed: Jul. 22, 2013

Related U.S. Application Data
(60) Provisional application No. 61/673,973, filed on Jul. 20, 2012.

(51) Int. Cl. G09G 5/377

(52) U.S. Cl. CPC G09G 5/377
USPC 345/633

(57) ABSTRACT

Augmented reality apparatus (10) for use during intervention procedures on a trackable intervention site (32) are disclosed herein. The apparatus (10) comprises a data processor (28), a trackable projector (14) and a medium (30) including machine-readable instructions executable by the processor (28). The projector (14) is configured to project an image overlaying the intervention site (32) based on instructions from the data processor (28). The machine readable instructions are configured to cause the processor (28) to determine a spatial relationship between the projector (14) and the intervention site (32) based on a tracked position and orientation of the projector (14) and on a tracked position and orientation of the intervention site (32). The machine readable instructions are also configured to cause the processor to generate data representative of the image projected by the projector based on the determined spatial relationship between the projector and the intervention site.

### CROSS REFERENCE TO RELATED APPLICATION AND CLAIM OF PRIORITY

The present application claims priority to U.S. provisional patent application No. 61/673,973 filed on Jul. 20, 2012, the entire contents of which are hereby incorporated by reference.

### TECHNICAL FIELD

The disclosure relates generally to augmented reality and more particularly to augmented reality apparatus and methods for use in medical and related applications

### BACKGROUND OF THE ART

Conventional image-guided systems have been used to enable clinicians to navigate medical instruments advancing in patient space during intervention procedures. Such systems typically involve the use of a monitor displaying medical images to guide the clinician to a target. Typically, the monitor is arranged in a stationary position, such as in-place on a desk or wall-mounted close to the patient's bed. With such an arrangement, the clinician's sight must be directed away from the operation field in order to view the monitor, which may result in difficulties for the clinician in interpolating and registering the image to the patient's physical space. The need for such mental interpolation and registration may lead to complications, for example if the clinician is not familiar with correlation of guidance image to the operation site or if the clinician lacks sophisticated hand-eye coordination training for the specific procedure.

Some existing systems include an autostereoscopic surgical display using integral videography technology that spatially projects 3D images on the surgical area, where the images are viewed via a half-silvered mirror. However, such integral videography display can be relative expensive and not commonly available.

Some image overlay systems adapted to conventional CT scanners are known. Such system consists of a LCD monitor and a half-mirror. Using triangular calibration object, the system can be calibrated pre-operatively to enable the display, half-mirror, and imaging plane of the scanner to spatially register into a common coordinate system. The clinician receives the image slice via the projection of a LCD monitor appearing on the reflective half-mirror while viewing the operating field through the half-mirror. However, such systems are non-mobile, may require the imaging device to be fixed in-place, and may be unable to display images that do not align with the imaging plane of the scanner.

Optical see-through head-mounted displays (HMDs) are also known. Using such displays, a clinician visualizes an augmented operating field via a miniature stereoscopic display and camera. A common drawback of HMD can include an indirect vision of the operating field, the need for extra equipment weight on the user's head thereby preventing long-time usage, and restricted user motion due to wiring associated with the head-mounted display.

Improvement is therefore desirable.

### SUMMARY

The present disclosure relates to apparatus, methods and medical devices for providing assistance to a broad spectrum of intervention procedures (e.g., surgical operation, needle biopsy, RF ablation, and surgical planning, among others). In various aspects and examples, the present disclosure provides apparatus and systems that may superimpose patient-specific medical image information on an intervention (e.g., surgical) site.

In one aspect, the disclosure describes an augmented reality apparatus for use during an intervention procedure on a trackable intervention site of a subject. The apparatus may comprise: at least one data processor; at least one trackable projector in communication with the at least one data processor and configured to project an image overlaying the intervention site based on instructions from the at least one data processor; and a medium including machine-readable instructions executable by the at least one processor and configured to cause the at least one processor to: determine a spatial relationship between the trackable projector and the trackable intervention site based on a tracked position and orientation of the projector and on a tracked position and orientation of the intervention site; access stored image data associated with the intervention site; using the stored image data, generate data representative of the image to be projected by the trackable projector based on the determined spatial relationship between the trackable projector and the trackable intervention site; and instruct the trackable projector to project the image.

In another aspect, the disclosure describes an augmented reality apparatus. The apparatus may comprise: at least one data processor; at least one trackable projector in communication with the at least one data processor and configured to project a medical image overlaying a trackable intervention site based on instructions from the at least one data processor; at least one tracking device configured to: track the position and orientation of the trackable projector; track the position and orientation of the trackable intervention site; and provide data representative of the position and orientation of the trackable projector and of the trackable intervention site to the data processor; and a medium including machine-readable instructions executable by the at least one processor and configured to cause the at least one processor to: determine a spatial relationship between the trackable projector and the trackable intervention site based on the tracked position and orientation of the projector and of the tracked position and orientation of the intervention site; access volumetric medical image data associated with the intervention site; using the volumetric medical image data, generate data representative of the medical image to be projected by the trackable projector based on the determined spatial relationship between the trackable projector and the trackable intervention site; and instruct the trackable projector to project the medical image.

Further details of these and other aspects of the subject matter of this application will be apparent from the detailed description and drawings included below.

### DESCRIPTION OF THE DRAWINGS

Reference is now made to the accompanying drawings, in which:

FIG. 1 shows the components of an exemplary augmented reality (AR) apparatus;

FIG. 2 shows a schematic representation of the apparatus of FIG. 1;

FIG. 3 shows a mobile unit of the AR apparatus of FIG. 1 during use;

FIG. 4 shows an exemplary first step for calibrating the apparatus of FIG. 1;

FIG. 5 shows an exemplary second step for calibrating the apparatus of FIG. 1;

FIG. 6 shows an exemplary graphic user interface of a navigation and visualization software; and

FIG. 7 shows an exemplary result of visual augmentation using the AR apparatus of FIG. 1;

FIGS. 8A-8F show another examplary graphical user interface of a navigation and visualization software used for optical augmentation during an intervention procedure on a rabbit where FIG. 8A shows an axial view of medical image data, FIG. 8B shows a coronal view of medical image data, FIG. 8C, shows a sagittal view of medical image data, FIG. 8D shows a projection image to be projected on the rabbit illustrating a tumor and lymph nodes, FIG. 8E shows a video feed of the intervention site without visual augmentation and FIG. 8F shows a video feed of the intervention site with visual augmentation;

FIG. 9A shows the rabbit of FIGS. 8A-8F with the projection image of FIG. 8D projected thereon prior to surgery and FIG. 9B shows the rabbit of FIGS. 8A-8F with the projection image of FIG. 8D projected thereon during surgery;

FIGS. 10A-10D respectively show exemplary axial, coronal, sagittal and 3D projection of combined PET and skeleton projection images of a mouse that may be projected with the apparatus of FIG. 1;

FIGS. 11A-11D respectively show exemplary axial, coronal, sagittal and 3D projection of combined CT and skeleton projection images of a mouse that may be projected with the apparatus of FIG. 1;

FIGS. 12A-12D respectively show exemplary axial, coronal, sagittal and 3D projection of combined PET/CT and skeleton projection images of a mouse that may be projected with the apparatus of FIG. 1;

FIGS. 13A-13D respectively show exemplary axial, coronal, sagittal and 3D projection of combined PET/CT and tumor model projection images of a mouse that may be projected with the apparatus of FIG. 1;

FIGS. 14A-14D respectively show exemplary axial, coronal, sagittal and 3D projection of combined PET and MRI images of a mouse that may be projected with the apparatus of FIG. 1; and

FIGS. 15A-15D respectively show exemplary axial, coronal, sagittal and 3D projection of combined SPECT and CT images of a mouse that may be projected with the apparatus of FIG. 1.

### DETAILED DESCRIPTION

The design and implementation of mobile handheld augmented reality apparatus and systems for image guidance suitable for use in intervention procedures are disclosed herein. Aspects of various embodiments are described below through reference to the drawings. An exemplary embodiment of a handheld augmented reality (AR) apparatus may be relatively compact and mobile, and may allow for medical imaging and/or planning data to be spatially superimposed on a visual target of interest, such as an intervention (e.g., surgical) site. In some examples, the AR apparatus may include a micro-projector, translucent display (also referred herein as a head-up display), computer interface, camera, instrument tracking system, head tracking system and dedicated software for real-time tracking, navigation and visualization (also referred herein as “X-Eyes”).

In some aspects, the disclose apparatus may provide one or more functionalities to augment viewing of an intervention site, such as by projecting medical images such as, for example, tomography (CT), magnetic resonance imaging (MRI), cone beam computed tomography (CBCT), positron emission tomography (PET), single-photon emission computed tomography SPECT, ultrasound and optical images and/or surgical planning contours (e.g. tumor and/or critical structure) on the patient surface. Projected image information can be either directly projected onto the target, or indirectly projected via, for example, a translucent display screen. Accordingly, the user may see correspondent virtual objects and/or medical images of the surgical site/operating field and the surgical site simultaneously. A calibration procedure may be conducted pre-operatively, which may help to ensure that the AR apparatus is projecting spatially accurate medical image information onto the patient. Additionally, the image space and tracking device(s) may be co-registered to a reference or world coordinate system to maintain accuracy during dynamic usage and/or re-location of handheld unit of the apparatus disclosed herein.

Throughout this disclosure, reference is made to “augmented reality” (AR) and “augmenting” of a procedure. These terms may be generally used to refer to systems and methods where a user's experience of the actual environment (e.g., an operating field of an intervention procedure) may be modified or enhanced by the addition of one or more computer-generated sensory data (e.g., audio, tactile and/or visual data) experienced by the user. In particular, “visually augmented” may refer to examples of AR where computer-generated visual data is presented to the user, overlaid on the user's view of the actual environment.

Disclosed herein are medical devices that may provide assistance to a clinician, physician or other personnel, for example during an intervention procedure, by visually augmenting the operation site with pre-operative and/or intra-operative image information. In some examples, the disclosed apparatus may help improve target localization, procedure performance and/or the health provider's confidence, and/or may help to reduce mental and/or physical demands of clinicians.

Unlike conventional AR technology, the apparatus disclosed herein may be designed to be relatively compact, handheld, mobile and/or compatible with multi-modal images. Instead of wearing a head-mounted device to achieve an AR view of a scene, the disclosed apparatus may visually augment the scene by use of a tracked handheld unit, and may also be used on-demand. The user may be able to freely relocate the disclosed AR unit with little or substantially no reduction of accuracy. In some examples, the hardware of the disclosed AR apparatus may include a pico-projector (e.g., illuminated by LED or LASER light source), a 3-dimensional (3D) tracking device for spatial localization of the handheld unit and of the intervention (e.g., surgical) site, a relatively low-reflective translucent screen, instruments (e.g., pointer(s), surgical tool(s) and/or other movable implement(s)) and a head tracking system for the user.

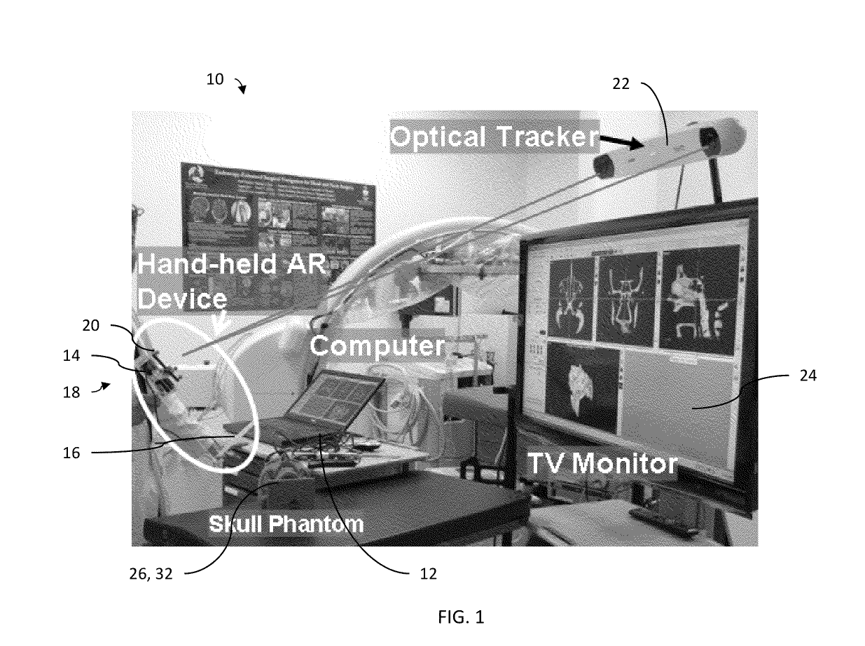

FIG. 1 shows components of an exemplary AR apparatus 10 in accordance with the present disclosure. AR apparatus 10 may comprise at least one computer 12 and at least one image projector 14, which may be in communication with computer 12. Projector 14 may be configured to project one or more images overlaying an intervention site of a patient based on instructions from computer 12.

Image projector 14 may be trackable so that its position and orientation may be monitored. Accordingly, computer 12 may be configured to receive data representative of the position and/or orientation of image projector 14. Such position and/or orientation may be used by computer 12 to select or generate one or more images to be projected by projector 14. Projector 14 may, for example, include a pico-projector that may be oriented to project toward the intervention site during use.

Translucent screen 16 may be rigidly or otherwise attached to projector 14 to form unit 18. Accordingly, in various embodiments, the spatial relationship between screen 16 and projector 14 may be fixed. The position and/or orientation of translucent screen 16 may be adjustable relative to projector 14. Unit 18 may be configured to be mobile, relatively compact and lightweight, and handheld by a user (e.g., clinician, surgeon). Alternatively or in addition, unit 18 may be configured to be mounted to an articulated arm (not shown) so as to be positioned and repositioned as needed by the user without the user needing to support unit 18 during use.

One or more trackable targets 20 such as optical reflective markers or other types of fiducial markers may be disposed on or in some known spatial relationship relative to projector 14 or any portion of unit 18. One or more trackable targets 20 may be disposed in a fixed spatial relationship to translucent screen 16 as well so that the position and/or orientation of translucent screen 16 may be determined in relation to projector 14 and/or other objects. Trackable targets 20 may be trackable via tracking device 22. Tracking device 22 may comprise an optical or other suitable types of tracking means. Tracking device 22 may be used to determine the position and orientation of unit 18 (and hence projector 14) and/or other trackable objects in 3D space. Tracking device 22 may be in communication with computer 12 and may provide real-time tracking and localization of mobile unit 18. Tracking device 22 and/or one or more other trackers of similar or different types may be used to track projector 14, the intervention site, the head or eyes of a user and other surgical tools or implements (such as drills, pointers, endoscopes and bronchoscopes, not shown in FIG. 1). Tracking device(s) 22 and trackable target(s) 20 may be used to track a number of objects in relation to a common reference coordinate system so that the spatial relationship between the various objects tracked may be used by computer 12 to select or generate appropriate image data for projector 14.

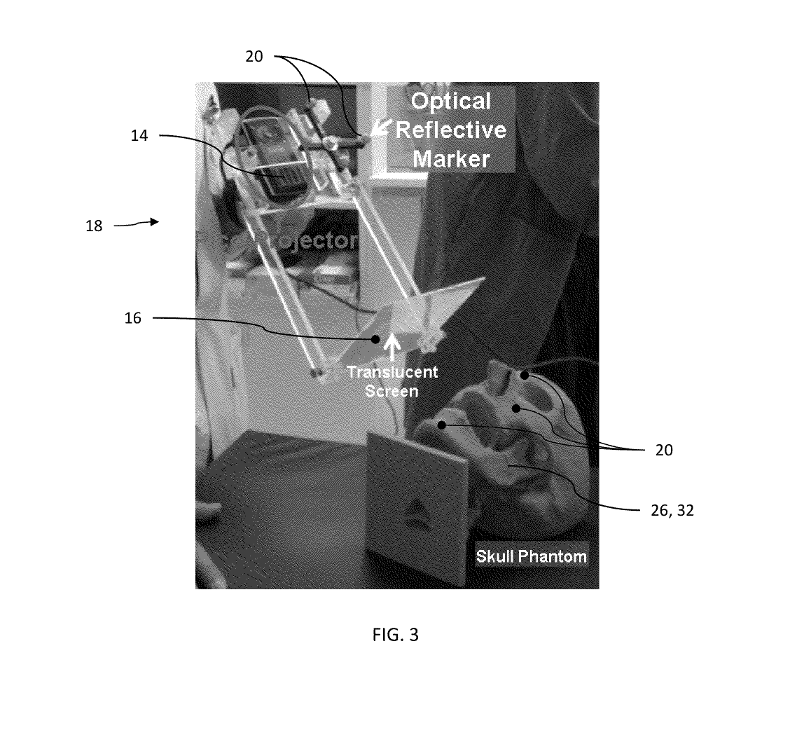

For example, the coordinate system registration of the tracking device space, patient's (e.g., site 32 shown in FIG. 3) space and image space may be rigid and may require fiducial markers (e.g., trackable targets 20) attached to the patient before medical imaging and also during the intervention procedure. In some embodiments, the registration of the patient space may take into consideration movement of the patient and/or deformation of the tissue at site 32. In various embodiments, computer 12 may take into consideration changes in registration of site 32 and make suitable modifications to the image to be projected by projector 14 to compensated accordingly. The location (data points) of the markers 20 may be identified in the tracking device space, patient's space and image space. The corresponding data points in different spaces may be used for registration of coordinate systems. The trackable targets 20 may not be limited to fiducial markers but they could also be other identifiable landmarks or structures within the tracking device space, patient's space and image space. For coordinate system registration, trackable targets 20 may be assumed to be relatively rigidly fixed on site 32 (e.g., patient). Using tracked instrument(s) 35, 38 may be used to touch/locate trackable targets 20 to obtain the data points from the tracked space. The same corresponding trackable targets 20 may be identified in the image space in order to register two sets of data points from the different spaces together.

In various embodiments, apparatus 10 may also comprise display monitor 24 in communication with computer 12 and which may be used to display user-selected, computer-selected or other images that may be associated with an intervention procedure. FIG. 1 also shows skull phantom 26 as an exemplary intervention site.

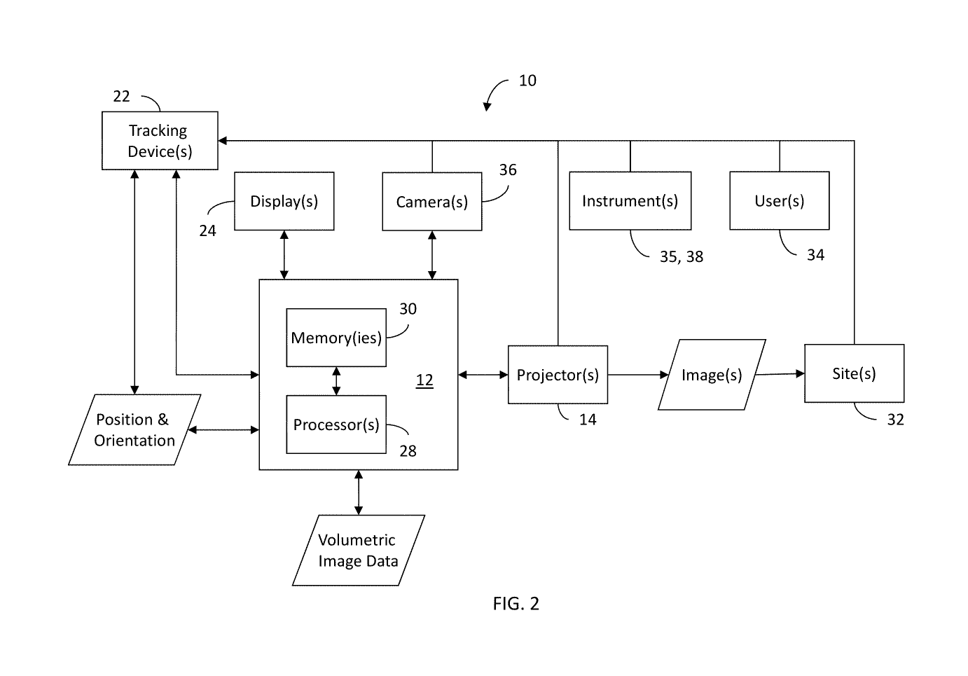

FIG. 2 shows a schematic representation of apparatus 10. Computer 12 may comprise one or more processors 28 that may execute appropriate machine-readable instructions (e.g., software, applications or modules) to perform various functions described herein. Processor(s) 28 may be coupled to one or more memories 30 (e.g., internal or external memories, including storage medium or media such as CDs or DVDs) that may tangibly store non-transitory machine-readable instructions and/or other data. Computer 12 may communicate (e.g., wirelessly or through wired connections) with one or more other systems and devices for receiving/transmitting data. Tracking device(s) 22 may be configured to track the positions and/or orientations of one or more of projector 14, intervention site 32, user 34 and instrument(s) 35, 38. Tracking device(s) 22 may then provide substantially real-time (i.e., dynamic) positional and/or orientation information for one or more of projector 14, intervention site 32 user 34 and instrument(s) 35, 38 to computer 12. The positional and/or orientation information may be used by computer 12 for generating instructions for projector 14.

Memory 30 may comprise machine-readable instructions executable by processor 28 and configured to cause processor 28 to determine a spatial relationship between trackable projector 14 and trackable intervention site 32 based on a tracked position and orientation of projector 14 and on tracked position and orientation of intervention site 32. Machine-readable instructions may also be configured to cause processor 28 to determine the spatial relationship between projector 14, site 32, user 34 and instrument(s) 35, 38 in relation to a common (e.g., world) coordinate system. Machine-readable instructions may also be configured to cause processor 28 to access stored (e.g., volumetric, medical) image data associated with intervention site 32, and then, using the stored image data, generate data representative of the image to be projected by trackable projector 14 based on the determined spatial relationship between trackable projector 14 and trackable intervention site 32. Processor 28 may instruct trackable projector 14 to project the selected or generated image(s). Apparatus 10 may also comprise one or more cameras 36 configured to capture still images and/or video.

FIG. 3 shows an example of a mobile, hand-held embodiment of unit 18 in use, where a clinician (i.e., user 34) is holding unit 18 for augmenting skull phantom 26, 32. With pre-operative calibration and co-registration, unit 18 may optionally project relatively geometrically and spatially accurate medical image information on translucent screen 16. A portion of the medical information may also be projected trough translucent screen 16 and onto skull phantom 26, 32. The clinician 34 may relatively accurately define a pre-operative procedure plan with appropriate medical image information appearing on translucent screen 16 in front of site 26, 32. Translucent screen 16 may comprise a substantially transparent substrate with a suitable filter applied thereon for reflecting some of the projected image back to user 34. In some embodiments, translucent screen 16 may comprise an optical filter in the form of a suitable film applied to an otherwise substantially optically transparent substrate such as glass or acrylic. Translucent screen 16 may be have a relatively low reflectivity and may permit user 34 to view the projected image(s) (i.e., virtual object(s)) and the actual site 32 simultaneously through screen 16.

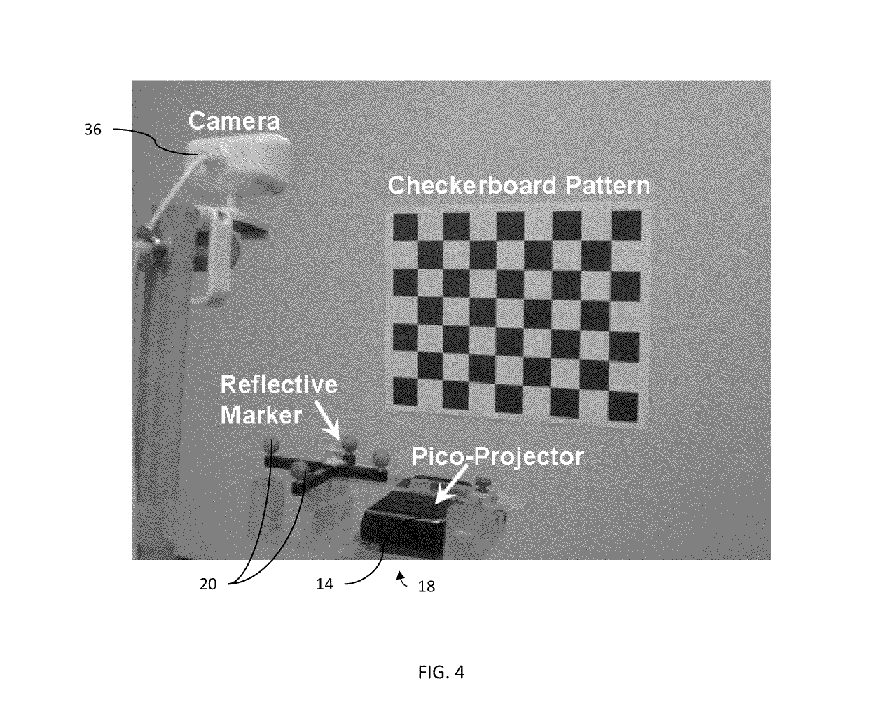

FIG. 4 shows an exemplary first step for calibrating a projector of apparatus 10. The calibration of projector 14 may comprise a camera-projector calibration process using camera 36. The illustrated calibration may be used to define the spatial relationship between camera 36 and trackable targets 20 (e.g., reflective optical markers, wired or wireless electrical sensors or other types of markers that may permit positional tracking) of unit 18. Tracking of unit 18 may be done in substantially real time. During the calibration procedure, unit 18 may be relocated to different positions while camera 36 captures an image of the exemplary checkerboard pattern shown at each location and records simultaneously the corresponding position and/or orientation of the trackable targets 20. In various embodiments, camera 36 may be part of apparatus 10 and may be used to capture still images and/or video of an intervention procedure. For example, camera 36 may be integrated into mobile unit 18 or, alternatively, may be disposed remotely from unit 18 and remain stationary during an intervention procedure.

The pre-operative calibration may be also be carried out to define the spatial relationship between trackable targets 20 and the center of projector 14, in terms of a homogeneous transformation matrix (other representation of transformation may be used). This spatial relationship may be determined by a camera-projector calibration procedure. For example, using a pin-hole camera model, the calibration procedure may provide intrinsic and/or extrinsic parameter(s) for both camera 36 and projector 14 of apparatus 10. The intrinsic parameter(s) may characterize one or more optical properties of apparatus 10, including, for example focal length, principle point, pixel skew factor and pixel size, while extrinsic parameter(s) may define the position and/or orientation of unit 18 with respect to a reference or world coordinate system. This parameter set may be further combined with the affixed trackable targets 20 locations to compute a final transformation matrix. For example, distortion of camera images may be corrected base on camera calibration parameters. Any other suitable known or other transformation techniques may be used.

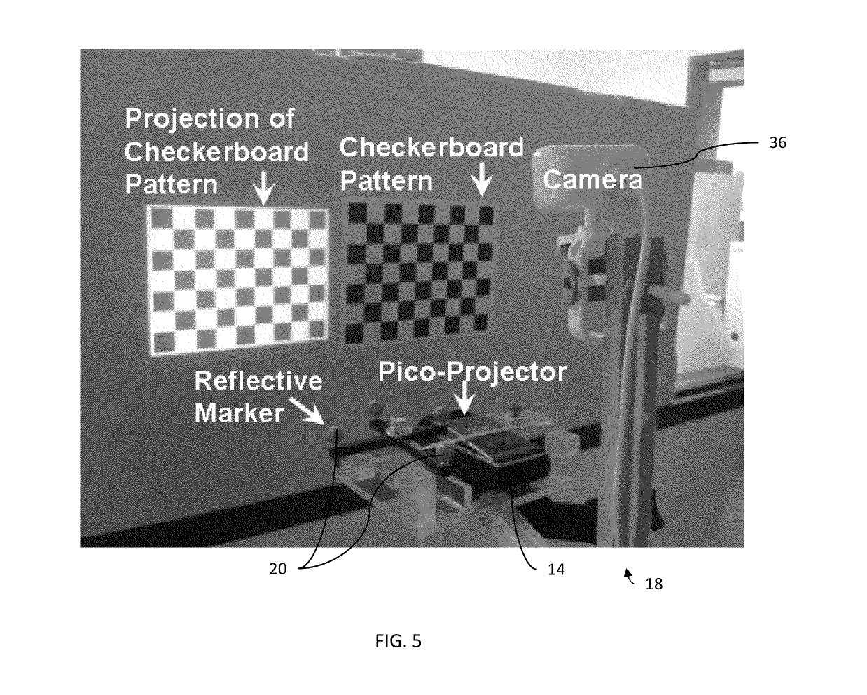

The exemplary camera-projector calibration procedure may be divided into two general steps: 1) camera calibration (as illustrated in FIG. 4); and 2) projector calibration (as illustrated in FIG. 5).

FIG. 5 shows an exemplary second step for calibrating projector 14 of apparatus 10. During the calibration procedure, unit 18 may be relocated to different positions while camera 36 captures an image including both a projection image of the checkerboard pattern and the real checkerboard pattern. This procedure may be used to define the spatial relationship between camera 36 and projector 14. Camera 36 may be in a fixed spatial relationship relative to projector 14 and mobile unit 18 for this procedure. Combining the result from a previous camera calibration step (e.g., as in FIG. 4), the spatial relationship may be determined and represented by a homogeneous transformation matrix (other representation of transformation may be used).

The camera calibration step may be adapted from known methods, which involve collection of different perspective images of a planar object of known size, such as a checkerboard pattern. At each camera location, the 3D coordinates of trackable targets 20 may be also recorded. The result of camera calibration may provide a spatial relationship between camera 36 and the tracked targets 20. Any other suitable techniques for camera calibration may be used.

The calibration of projector 14 may be conducted in a similar manner as the calibration of camera 36. However, camera 36 may be concurrently capturing the projection of the checkerboard pattern from projector 14 and the image of the real checkerboard pattern. This projector calibration step may provide the spatial relationship between camera 36 and projector 14. Any other suitable techniques for the calibration of projector 14 calibration may be used.

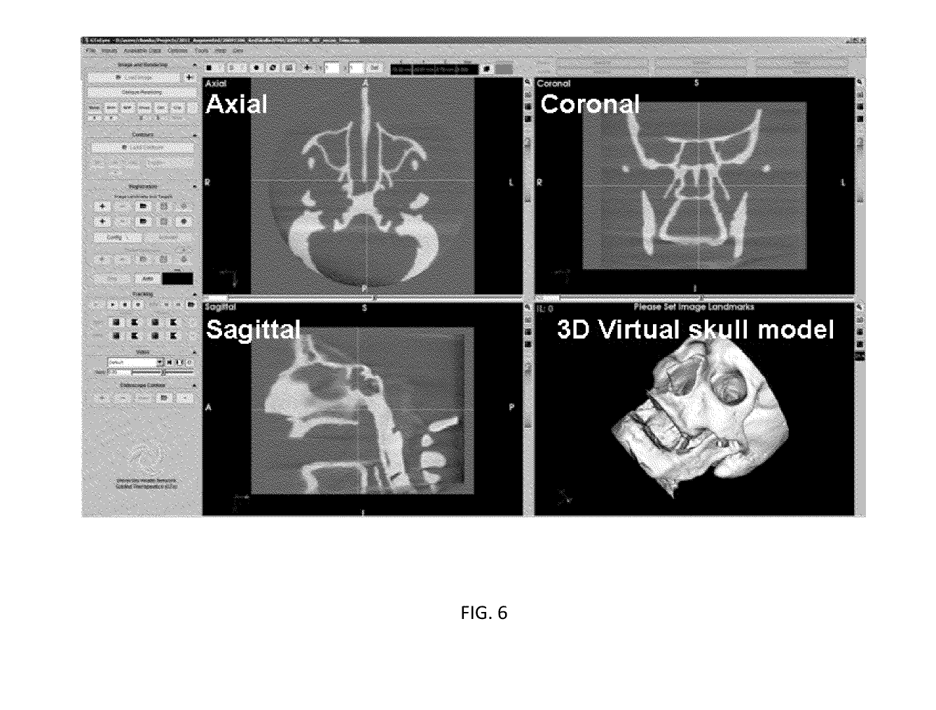

Combining the results from the first and second calibration steps, the spatial relationship of projector 14 to trackable targets 20 may be represented by a transformation matrix. In actual implementation, this transformation matrix may be stored in a real-time tracking and visualization software (also referred herein as “X-eyes”) (see, for example, FIG. 6), allowing projector 14 to be tracked within the reference or world coordinate system.

To help ensure that projector 14 and/or any other intervention (e.g., surgical) tools are tracked in the patient's space, the co-registration procedure may aim to fuse or co-register the patient's coordinate system, the tracking device's coordinate system and the image coordinate system to each other. This procedure may include selection of identifiable landmarks from image space (e.g., a minimum of 3 landmarks, though more or less may be suitable in various applications) and the corresponding landmarks from the patient's space. The paired landmarks may be then registered to each other mathematically, for example by optimizing the root-mean-square distance between a pair of data points. Any other suitable techniques for co-registration may be used.

The registration result may be represented by means of a rigid transformation matrix, which may allow tracked instruments in the tracking device's coordinate system to be transformed to the patient's coordinate system. Using the result from the pre-operative calibration and co-registration, projector 14 may be tracked in the patient's coordinate system and co-registered in the image space. When apparatus is under operation, projector 14 may accept an image of the scene from a virtual camera in the image space and may then subsequently project a relatively geometrically and spatially accurate image to the real world in the patient space.

The above approaches may be sufficient to project spatially correct images on a planar target object. However, the projected image may be distorted if the projection surface is non-planar (i.e. a non-flat surface) that may cause the projected image to deform according to the surface geometry. In some examples, a solution may be provided by using a head-up display using translucent screen 16 installed in front of projector 14. The head-up display may provide a suitable planar surface that captures a 2D projection to be displayed before it reaches the surface of site 32, while still allowing user 34 to see through screen 16 and view site 32 with visual augmentation.

Implementation of this embodiment may include mathematically defining the location of translucent screen 16 in unit 18. This definition may be expressed as a homography matrix for correcting the image on translucent screen 16, if necessary, based on the spatial relationship between projector 14 and translucent screen 16. An alternative way of computing a 3×3 homography matrix is applying least square optimization method for the correspondent points from projection image and real object on the screen. This homography matrix is then stored in the “X-Eyes” visualization and navigation software for wrapping a camera image from virtual space before the projection in order to compensate the distortion that may be introduced by translucent screen 16.

When using a head-up display, parallax issues may arise when the user's prospective view is not collinear to the display and viewing area. In some examples, this issue may be addressed by tracking the user's head location to determine the viewpoint of the user. Tracking may be carried out by various techniques including, for example: using an additional head tracking system installed at the working area; using an existing instrument tracking system by affixing trackable targets 20 to the user's head; and including a head tracking device (e.g., stereoscopic tracking) in apparatus 10.

Using an additional head tracking system installed at the working area may require co-registering the head tracking system to the existing instrument tracking system, for example by detecting objects in common space. In some examples, known object tracking devices may be used, such as the Microsoft™ Kinect™ system, which may be capable of providing 3D location, including position and orientation of a moving human subject in real-time.

Using an existing instrument tracking system by affixing trackable target(s) 20 on the user's head may require only attachment of trackable target(s) 20 on the human head, which may eliminate the need for an additional co-registration procedure. Including a head tracking device to apparatus 10 may require pre-operative calibration of the head tracking device to define the spatial relationship of apparatus 10 to the trackable targets attached to the user's head.

Using the above described procedures, a main goal of head tracking is to localize the position and direction of viewer perspective in space and simulating the camera view in virtual world. The viewer's perspective information may then be further combined with the homography matrix to resolve the parallax issues. The processing of all these information and real-time computation may be achieved in the “X-Eyes” software. The positional and/or orientation of the head of user 34 may be used, in addition to or instead of positional and/or orientation of other components disclosed herein, by computer 12 for generating instructions for projector 14.

FIG. 6 shows an exemplary graphic user interface of a real-time navigation and visualization software referred herein as “X-Eyes”, which may be displayed on display 24 and provide an interface for apparatus 10. This software may provide real-time tracking of unit 18 and/or other medical instruments. Combining the pre-operative calibration and co-registration results, the medical image information may be relatively accurately superimposed on the procedure site. The visual augmentation may be based on volumetric medical image data and may include virtual objects/models of anatomical structures such as critical structures, soft tissue structures, bone tissue structures, organs, nerves, tumors and lesions associated with a human or other subject. The visual augmentation may include images such as object-specific CT, MRI, CBCT, PET, SPECT, ultrasound and optical images and may be useful for pre-operative planning. In the example shown in FIG. 6, a CBCT volumetric image is displayed in axial, coronal, sagittal views as well as a 3D virtual skull model for visual augmentation.

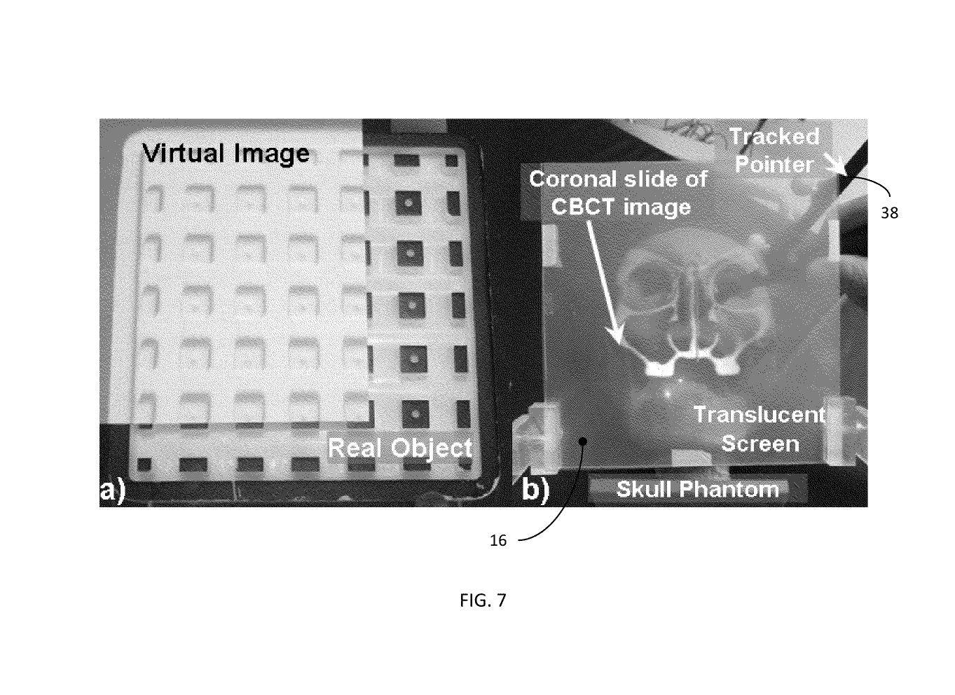

A limitation of conventional technology may be its limited use for multi-slice image display. Conventional systems typically require reconfiguration and/or re-calibration if different slices of images are to be employed for visual augmentation. This may be a cumbersome procedure, which may be avoided by the apparatus disclosed herein. With suitable pre-operative calibration prior to operation and co-registration, apparatus 10 may be capable of maintaining accuracy over the course of a procedure, for example if there are no severe changes of subject and/or environment. Once the image space and tracking device space are co-registered, the user may manipulate the image slices, for example by using a suitable computer interface (e.g. a mouse) or suitable tracking tools. Since the tracked tools may be registered to the image space, the location of the tips of such tools in the image space may be known at all times. Based on the tip location, the image volume may be re-sliced and displayed in a tri-planar view (e.g., axial, coronal and sagittal) with respect to the tip location (for example as illustrated in FIG. 7). This option for image manipulation may provide the user with the capability to view image volume from different perspectives. This may be useful for broad spectrum intervention procedure planning (e.g. in needle biopsy, for advancing the needle to the target without damage to adjunct critical structures).

FIG. 7 shows an exemplary result of visual augmentation using apparatus 10. The left hand side of FIG. 7 shows an image of a virtual computer model directly overlaid on the real object (in this case a checkerboard plate). The image of the virtual model in this example is generated from a CBCT scan using threshold segmentation technique. The right hand side of FIG. 7 demonstrates the use of translucent screen 16 for displaying the coronal slice of a CBCT image of skull phantom 26, 32. Tracked movable implement 38 may be manipulated by user 34 to select or control the image (e.g., slice) projected by projector 14. For example, the maniplulation of implement 38 may caused computer to generate data representative of the image to be projected by the trackable projector 14 based on a position of movable implement 38. Movable implement 38 may, for example, comprises a tracked pointer or other tracked surgical tool. In various embodiments, the position of movable implement 38 may be used to select a depth of the intervention site 32 and the image to be projected may be based on stored image data at the selected depth. In various embodiments, the position of movable implement 38 may be used to select a region of the intervention site 32 and the image to be projected may be based on stored image data associated with the selected region. For example, the use of movable implement 38 relative to site 32 may provide image manipulation and the user may review different image slices corresponding to the tracked position of movable implement 38.

In some examples, the disclosed apparatus may also incorporate a functionality to provide a proximity alert. For example, prior to the intervention procedure the user may define critical structures and/or a proximity zone on a volumetric image data. The proximity zone may represent a safety buffer zone that may be used to alert the clinician when a medical or other tracked instrument moves close to a protected area, such as normal tissue. Using real-time tracking, the tip of a tracked instrument may be located at all times within image space. When the tip's position is detected (e.g., using interface software) within the proximity zone, an auditory, visual and/or tactile (e.g., vibration via a handheld tool/implement) alert may be provided to warn the user of a potentially adverse event. Such a proximity alert may in some instances help minimize or reduce the risk of complications during a procedure.

In various aspects and examples, apparatus 10 as disclosed herein may provide various benefits across various image-guided intervention procedures including, for example, surgery, intervention radiology and radiation therapy, among others. A clinical model in which an example of the disclosed system may be used is in sentinel node biopsy. Conventionally, this procedure may be performed by injecting into the patient a radionuclide tracer preoperatively, followed by an intraoperative tracer blue dye. Then, the surgeon may make an incision and search for the lymph node which has taken up the radionuclide and has accumulated the most blue dye. However, due to skin and muscle soft tissue deformation, identifying the targeted node can be challenging. With an example of the disclosed apparatus, the surgeon may project and overlay a PET- or SPECT-CT image to localize the node position. An example of the disclosed AR apparatus 10 may also be used in open surgical procedures by overlaying the position of critical structures and/or lesions within the surgical site. For example, examples of the disclosed system may be suitable for application in head and neck, thoracic, liver, brain and orthopedic surgery, among others.

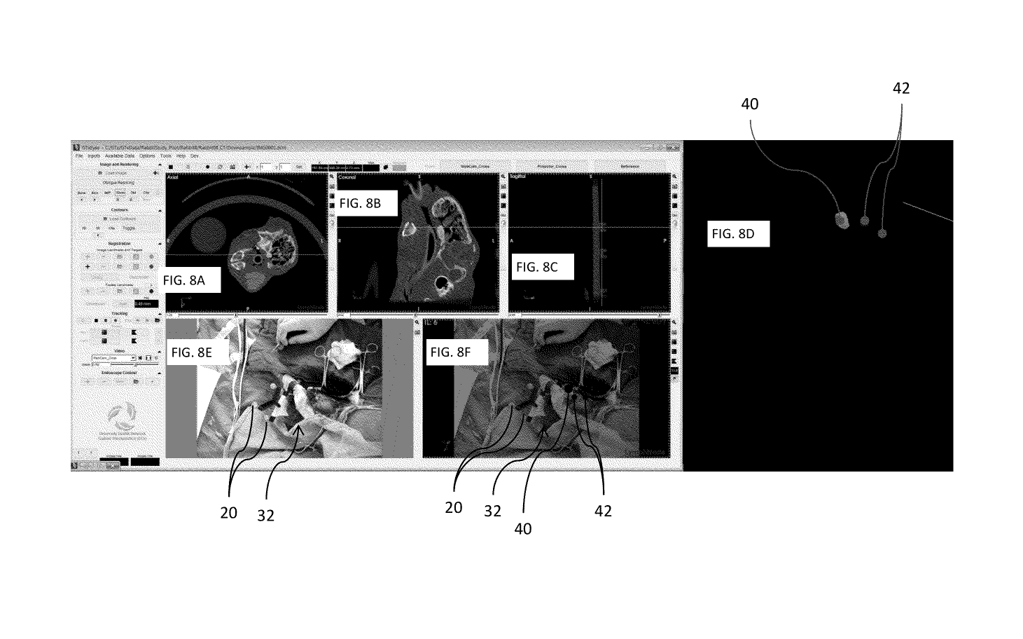

FIGS. 8A-8F show a graphical user interface of a navigation and visualization software used for optical augmentation during an intervention procedure on a rabbit. The software may facilitated substantially real time tracking and optical augmentation FIG. 8A shows an axial view of medical image data. FIG. 8B shows a coronal view of medical image data. FIG. 8C, shows a sagittal view of medical image data. FIG. 8D shows a projection image to be projected on the rabbit illustrating tumor 40 and lymph nodes 42. The projection image of FIG. 8D may show tumor 40 and lymph nodes 42 in different color to facilitate visual contrast between the two types of features of interest. The projection image of FIG. 8D may be generated by computer 12 and may be based on a combination of different medical imaging modalities. The projection image of FIG. 8D may be generated based on user input also. The projection image of FIG. 8D may be projected onto the rabbit using projector 14 of unit 18. FIG. 8E shows a video feed of the intervention site without augmentation and FIG. 8F shows a video feed of the intervention site with optical augmentation (i.e., with the projection image of FIG. 8D projected onto the rabbit). The video feed shown in FIGS. 8E and 8F may be obtained via camera 36 of apparatus 10 (see FIGS. 2, 4 and 5). In various embodiments, in order to form the video display of FIG. 8F, the video feed of FIG. 8E (e.g., from camera 36) may be digitally combined (e.g., fused) with the projection image of FIG. 8D according to known of other methods. The video feed of FIG. 8E may be combined with other digital images depending on the specific situation. The software may also permit video recording of the procedure via camera 36 or other tool-mounted camera such as on an endoscope for example. The software may be run on computer 12 and may be integrated with apparatus 10, tracker 22 and any other tracked implement, tool or object.

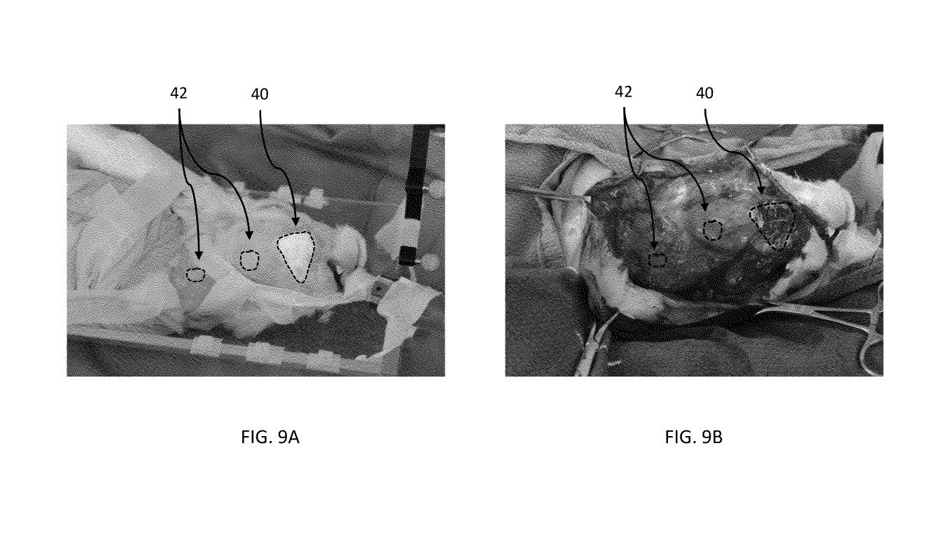

FIG. 9A shows the rabbit of FIGS. 8A-8F with the projection image of FIG. 8D projected thereon prior to surgery. FIG. 9B shows the rabbit of FIGS. 8A-8F with the projection image of FIG. 8D projected thereon during surgery. Stippled lines have been added around the projected images of tumor 40 and lymph nodes 42 for illustration purpose and such stippled lines may or may not necessarily be projected by projector 14. Instead or in addition, tumor 40 and lymph nodes 42 may be projected as areas of different colors (e.g., green, blue) that are easily distinguishable within rabbit (i.e., site 32).

As mentioned above, images for projection by projector 14 may be computer-generated images that are user-selected and/or generated by computer 12 based on volumetric medical image data associated with site 32. The projected image(s) may in various embodiments be based on the tracked position of projector 14, site 32, user 34 and implement 38. The projected image(s) may also be based on a combination (e.g., merging) of different imaging modalities. For example, such combination may comprise the superimposition of image data originating from different imaging modalities and/or may comprise the fusion of such image data originating from different imaging modalities. For example, such different imaging modalities that may be at least partially combined to form the projected image(s) may include CT, MRI, CBCT, PET, SPECT, ultrasound and optical images. Image fusion may comprise the merging of at least two images in accordance with known or other methods. The at least two fused images could be acquired from same modality or from different modalities. The technique of fusing images may depend on the kind of images that are being fused. Generally, image fusion may involve: 1) image registration (rigid or deformable registration method); and 2) fusing (which could be relatively simple by controlling the opacity parameter or relatively more complex by using a wavelet transform).

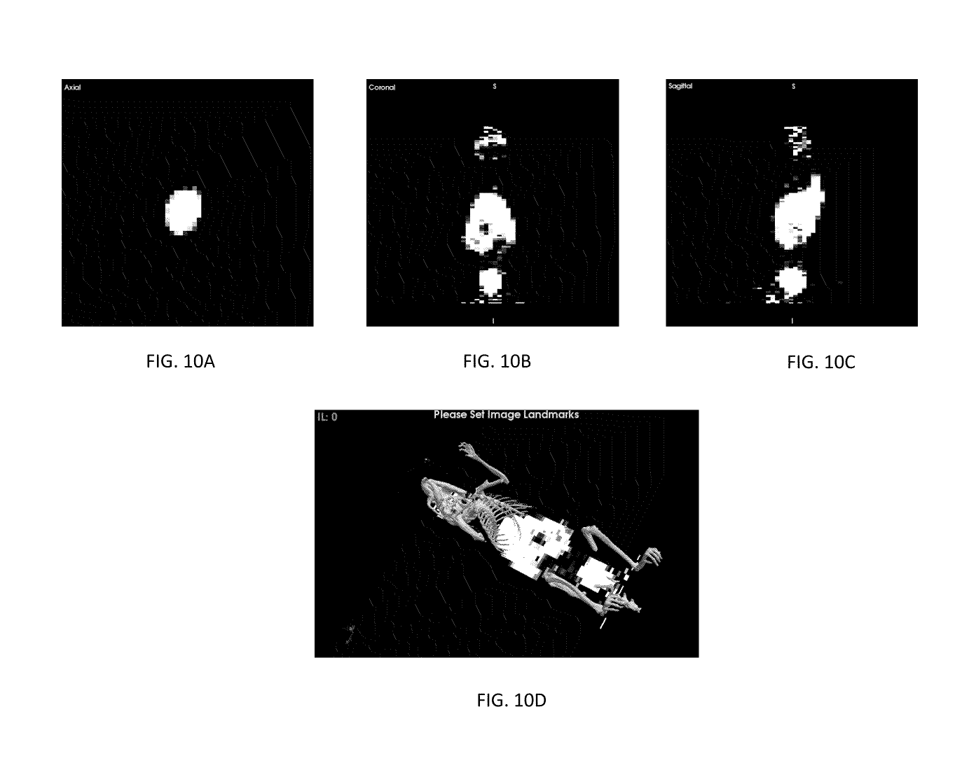

Various examples of projected images based on combinations of imaging modalities are explained below in reference to FIGS. 10A-10D to 15A-15D. A projected image could also be a 2D image interpolated from volumetric image data. Also, virtual models including surgical planning and contour of anatomical structures created from one medical image may be transformed to another medical image using rigid and/or deformable image registration methods. Image registration may be used to transform one (volumetic) image to another (volumetric) image. A deformable registration may be applied where soft tissue deformation occurs in site 32. Visual adjustments such as image opacity parameters may be made to individual image modalities or to combinations of image modalities.

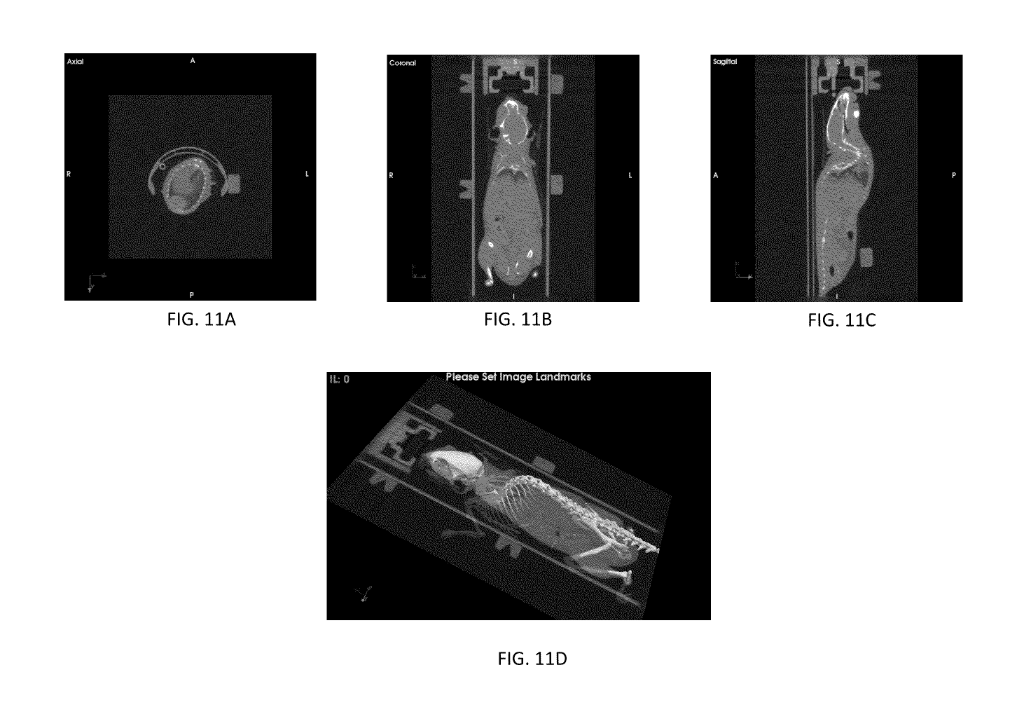

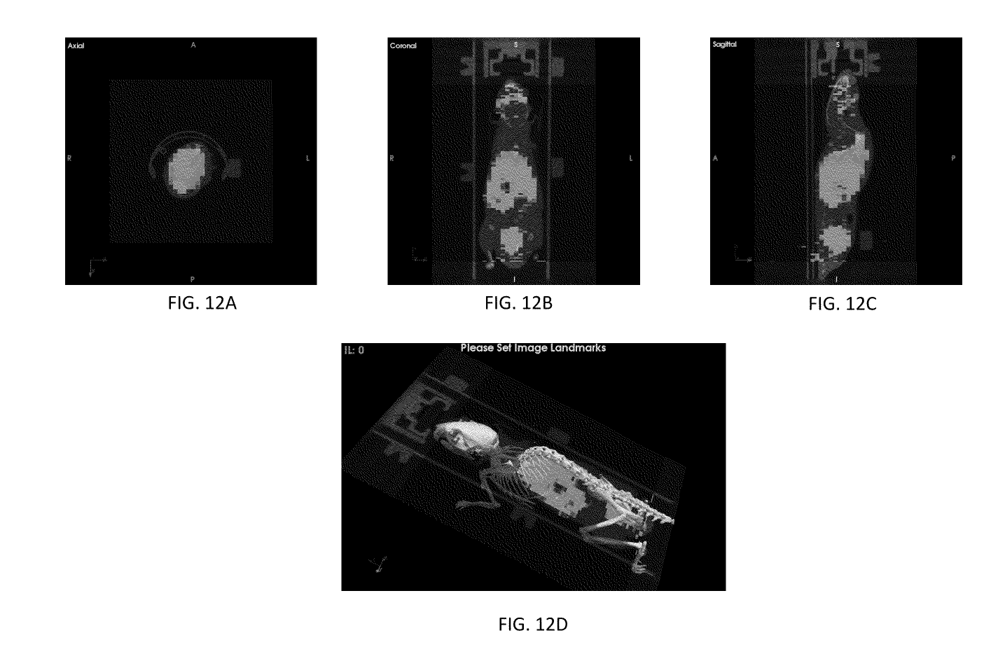

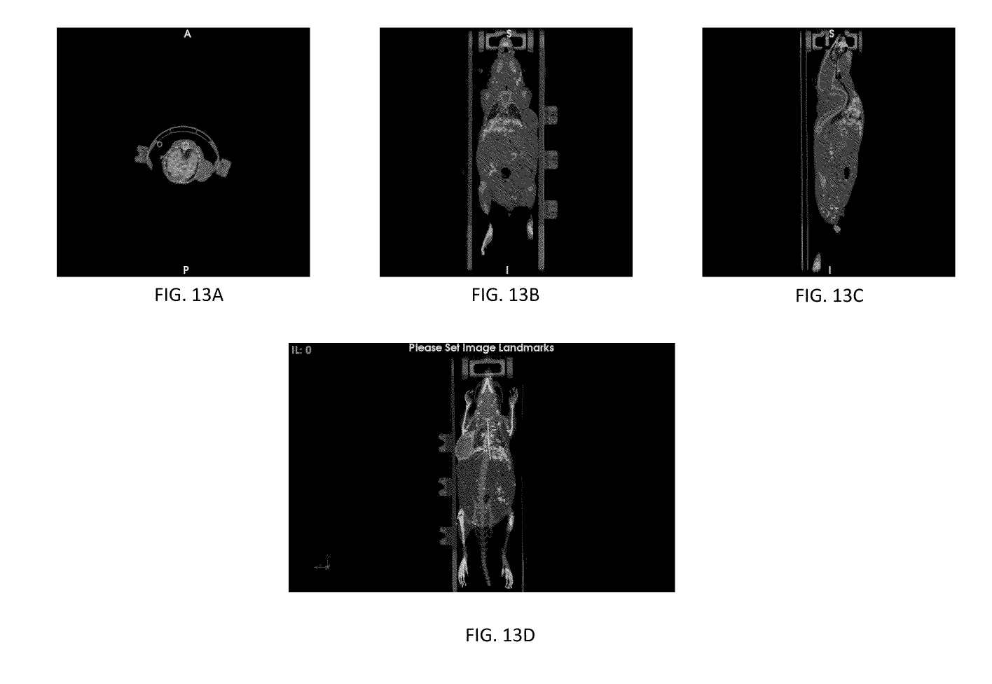

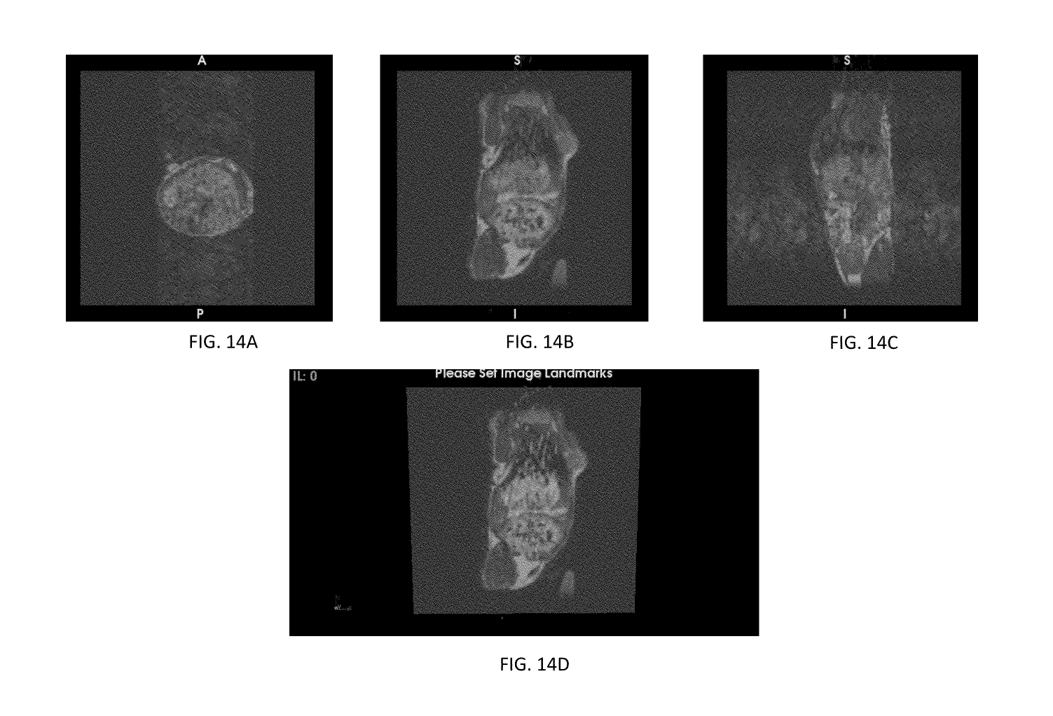

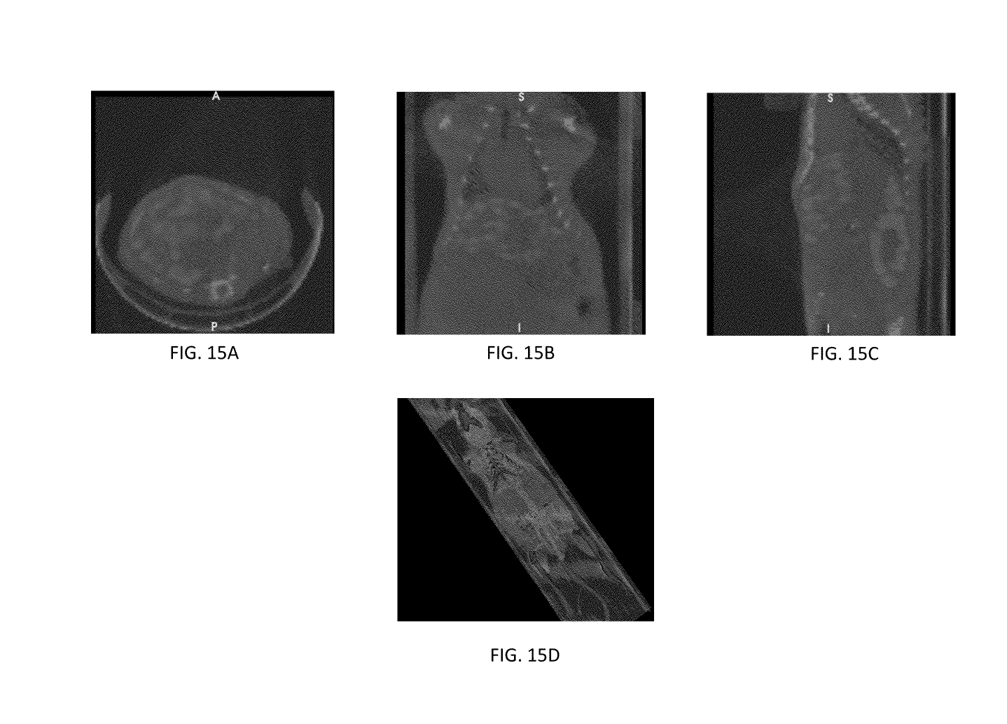

FIGS. 10A-10D are exemplary axial, coronal, sagittal and 3D projection combined PET and skeleton projection images respectively of a mouse subject that may be projected with projector 14 of apparatus 10. FIGS. 11A-11D are exemplary axial, coronal, sagittal and 3D projection combined CT and skeleton projection images respectively of a mouse subject that may be projected with projector 14 of apparatus 10. FIGS. 12A-12D are exemplary axial, coronal, sagittal and 3D projection combined PET/CT and skeleton projection images respectively of a mouse subject that may be projected with projector 14 of apparatus 10. FIGS. 13A-13D are exemplary axial, coronal, sagittal and 3D projection combined PET/CT and tumor model projection images respectively of a mouse subject that may be projected with projector 14 of apparatus 10. FIGS. 14A-14D are exemplary axial, coronal, sagittal and 3D projection combined PET and MRI images respectively of a mouse subject that may be projected with projector 14 of apparatus 10. FIGS. 15A-15D are exemplary axial, coronal, sagittal and 3D projection combined SPECT and CT images respectively of a mouse subject that may be projected with projector 14 of apparatus 10.

The above description is meant to be exemplary only, and one skilled in the relevant arts will recognize that changes may be made to the embodiments described without departing from the scope of the invention disclosed. The present disclosure may be embodied in other specific forms without departing from the subject matter of the claims. Also, one skilled in the relevant arts will appreciate that while the systems, devices and assemblies disclosed and shown herein may comprise a specific number of elements/components, the systems, devices and assemblies could be modified to include additional or fewer of such elements/components. The present disclosure is also intended to cover and embrace all suitable changes in technology. Modifications which fall within the scope of the present invention will be apparent to those skilled in the art, in light of a review of this disclosure, and such modifications are intended to fall within the appended claims.

What is claimed is:

1. An augmented reality apparatus for use during an intervention procedure on a trackable intervention site of a subject, the apparatus comprising:
at least one data processor;
at least one trackable projector in communication with the at least one data processor and configured to project an image overlaying the intervention site based on instructions from the at least one data processor; and
a medium including machine-readable instructions executable by the at least one processor and configured to cause the at least one processor to:
determine a spatial relationship between the trackable projector and the trackable intervention site based on a tracked position and orientation of the projector and on a tracked position and orientation of the intervention site;
access stored image data associated with the intervention site;
using the stored image data, generate data representative of the image to be projected by the trackable projector based on the determined spatial relationship between the trackable projector and the trackable intervention site; and
instruct the trackable projector to project the image.

2. The augmented reality apparatus as defined in claim 1, wherein the stored image data comprises data associated with a plurality of imaging modalities.

3. The augmented reality apparatus as defined in claim 1, wherein the projected image is based on a combination of data from plurality of imaging modalities.

4. The augmented reality apparatus as defined in claim 3, wherein the imaging modalities comprise at least two of computed tomography (CT), magnetic resonance imaging (MRI), cone beam computed tomography (CBCT), positron emission tomography (PET), single-photon emission computed tomography (SPECT), ultrasound and optical images.

5. The augmented reality apparatus as defined in claim 1, comprising a movable implement where the at least one processor is caused to generate data representative of the image to be projected by the trackable projector based on a position of the movable implement.

6. The augmented reality apparatus as defined in claim 5, wherein the movable implement comprises a tracked handheld pointer.

7. The augmented reality apparatus as defined in claim 5, wherein the position of the movable implement is used to select a depth of the intervention site and the image to be projected is based on stored image data at the selected depth.

8. The augmented reality apparatus as defined in claim 1, wherein the at least one processor is caused to generate data representative of the image to be projected by the trackable projector based on a tracked position of a user.

9. The augmented reality apparatus as defined in claim 1, wherein the at least one processor is caused to generate data representative of the image to be projected by the trackable projector based on a tracked position and orientation of a head of a user.

10. The augmented reality apparatus as defined in claim 1, comprising a translucent screen onto which the projector projects the image.

11. The augmented reality apparatus as defined in claim 10, wherein the translucent screen and the trackable projector are in fixed spatial relationship to one another and form a mobile handheld unit.

12. The augmented reality apparatus as defined in claim 9, wherein the at least one processor is caused to generate data representative of a proximity alert when a tracked position of a tool is proximate or within a region of interest in the stored image data.

13. An augmented reality apparatus comprising:
at least one data processor;
at least one trackable projector in communication with the at least one data processor and configured to project a medical image overlaying a trackable intervention site based on instructions from the at least one data processor;
at least one tracking device configured to: track the position and orientation of the trackable projector; track the position and orientation of the trackable intervention site; and provide data representative of the position and orientation of the trackable projector and of the trackable intervention site to the data processor; and
a medium including machine-readable instructions executable by the at least one processor and configured to cause the at least one processor to:
determine a spatial relationship between the trackable projector and the trackable intervention site based on the tracked position and orientation of the projector and of the tracked position and orientation of the intervention site;
access volumetric medical image data associated with the intervention site;
using the volumetric medical image data, generate data representative of the medical image to be projected by the trackable projector based on the determined spatial relationship between the trackable projector and the trackable intervention site; and
instruct the trackable projector to project the medical image.

14. The augmented reality apparatus as defined in claim 13, comprising a translucent screen onto which the trackable projector projects the medical image, the translucent screen and the trackable projector forming a mobile handheld unit.

15. The augmented reality apparatus as defined in claim 14, wherein the at least one tracking device is configured to track a position of a head or an eye of a user and the at least one processor is caused to generate data representative of the image to be projected by the trackable projector based on the tracked position of the head or eye of the user.

16. The augmented reality apparatus as defined in claim 13, wherein the volumetric image data comprises data associated with a plurality of imaging modalities comprising at least two of computed tomography (CT), magnetic resonance imaging (MRI), cone beam computed tomography (CBCT), positron emission tomography (PET), single-photon emission computed tomography (SPECT), ultrasound and optical images.

17. The augmented reality apparatus as defined in claim 16, wherein the projected image is based on a combination of the plurality of imaging modalities.

18. The augmented reality apparatus as defined in claim 13, comprising a movable implement and the at least one processor is caused to generate data representative of the image to be projected by the trackable projector based on a position of the movable implement.

19. The augmented reality apparatus as defined in claim 18, wherein the position of the movable implement is used to select a region of the intervention site and the image to be projected is based on volumetric medical image data at the selected region.

20. The augmented reality apparatus as defined in claim 18, wherein the at least one processor is caused to select a slice of volumetric medical image data to be used as a basis for the projected image based on the position of the movable implement.
